(19) United States
(12) Patent Application Publication
(10) Pub. No.: US 2002/0046245 A1
(43) Pub. Date: Apr. 18, 2002

(54) System and method for creating customized web pages

(76) Inventors: Christopher J. Hillar, Houston, TX (US); Christopher W. Priebe, Houston, TX (US)

Correspondence Address: KING & SPALDING, 191 PEACHTREE STREET, N.E., ATLANTA, GA, 30303-1763, US

(21) Appl. No.: 09/930,695

(22) Filed: Aug. 15, 2001

Related U.S. Application Data
(60) Provisional application No. 60/236,862, filed on Sep. 29, 2000.

(51) Int. Cl. G06F 15/16

(52) U.S. Cl. 709/205; 345/788

(57) ABSTRACT

A computer-implemented system for creating web pages of complex design that are viewable via a network. The system employs a web authoring software module that is platform-independent and can be accessed by clients to create customized web pages. A client can select the size and location of information elements to be placed on the web page without complex programming or the use of templates. The system also supports the use and editing of multiple information elements, such as images, of various formats.

### PRIORITY APPLICATION

This application claims priority to provisional patent application entitled “Presto Stores/Online WYSIWYG Web Authoring Tools,” filed on Sep. 29, 2000 and assigned U.S. Ser. No. 60/236,862.

### TECHNICAL FIELD

The present invention is generally directed to the creation of customized files of information for viewing on the World Wide Web. More specifically, the present invention provides a software module that enables users to easily create customized web pages of varying content and layout.

### BACKGROUND OF THE INVENTION

The Internet has quickly become a popular means for transmitting information because of the world-wide access it provides to information resources. The information on the Internet is available in a variety of formats and it can have educational, entertainment, or business purposes. The World Wide Web (the “Web”) is one of the largest and most popular distributed computing networks that make-up the Internet. The Web comprises interconnected computers from around the world. A computer connected to the Internet can download digital information from Web server computers. The Web comprises resources and clients that communicate digital information and instructions typically using a format known as Hypertext Markup Language (HTML). These instructions can include information for formatting text, linking to digital data, and receiving digital data.

Typically, the Web server computers that comprise the World Wide Web have files of information called web pages that can be displayed on a remote computer. A person operating the remote client computer connected to the Internet can use a software module called a browser to view the files of information available on the Web. The files of information, or web pages, can include menu choices and highlighted words that provide connections to further information.

Somewhat analogous to a yellow pages telephone directory, web pages are commonly used today to provide information. However, beyond just traditional business information available in a telephone directory, web pages can provide access to a wide variety of personal, educational, commercial, and entertainment information. Accordingly, many people, who are not necessarily proficient with HTML, have the need to create their own customized web pages.

There are several commercially available software modules that allow people to create and edit web pages without knowing how to use HTML. However, existing web authoring software modules do not support the creation of complex web pages of varying design. The conventional applications generally require a user to choose the format of a web page from a few web templates. The user can then enter information in certain fields, or designated areas within the templates. The user's ability to create web pages of sophisticated and customized design is limited when an application employs templates with designated fields for inputting information.

Another conventional method, different from the template approach, is for a user to download HTML authoring software from the Web to their PC. This HTML authoring software is generally more sophisticated than the above-described template software modules and allows the user to create a variety of designs for web pages. However, the HTML authoring software requires the user to design a page on her PC and then upload the file containing the HTML instructions to a server which hosts the web page. This approach can result in errors in the HTML code which can cause malfunctioning with the web page. Errors can arise because the HTML authoring software is more complicated for the user than the conventional web authoring software described above. An additional complication is that HTML authoring software generally is not platform independent.

In view of the foregoing, there is a need in the art for a system which will support the easy creation of web pages of varying design. Specifically, a need exists to easily create web pages comprising a variety of text and graphical images in unrestricted configurations. A further need exists to be able to incorporate images of varying formats into the web page. There is also a need to be able to edit images incorporated into the web page. Finally, a need exists to be able to create a web page that is platform independent.

### SUMMARY OF THE INVENTION

The present invention is generally directed to a method and system for creating web pages that comprises a web authoring software module running on a server computer and that is accessed via a distributed computing network. The user can access the web authoring software module which allows the user to place information elements on a web page. The information elements can comprise one or more of text, tables, images, hyperlinks, music, sound, movies or video, calendars, events, clocks or time functions, web page hit counters, and other like information elements. The user can choose the size and the location of the information elements on the web page. That is, the size and location of the information elements is constrained only by the bounds of the file, or web page, as it is viewed on the distributed computing network.

Once the user selects information elements, the web authoring software module can display a preview of the customized information elements as they will look on the web page, without the user having to exit the software and view the web page with a browser. In other words, the authoring software module then can display the information elements, and any media contained therein, as they would appear on the distributed computing network if they were accessed by another remote web browser.

Existing approaches for creating web pages with a web browser are either too simplistic or too complicated. Conventional web authoring software can be constraining in that it only provides a limited number of templates for creating a few styles of web pages. On the other hand, attempting to use HTML authoring software can often be complex and result in formatting problems. In contrast, the present invention is a software module that can place a variety of media at any location on the web page that the user desires.

If the user desires to place an image on the web page, it may be retrieved from a database coupled to the web authoring software module. The user may also retrieve images available on other databases. The web authoring software module can support editing of images and formatting images stored in different types of files. More specifically, in one exemplary embodiment, images selected or provided by the user can be resized in a very efficient manner. The resizing can first be accomplished with a web browser based upon modifications to HTML code. Once a user deems a resized image to be acceptable, the image can then be re-sized on the server computer side. In this way, rapid previews of the re-sized image can be provided before an image is resized on the server side of the system.

The present invention supports a method and system for creating web pages wherein the user can place additional information elements within an information element. This approach, called nesting of information elements, can give the user more flexibility than conventional approaches to designing a web page. Stated differently, nesting of information elements allows for a greater variety of formats for arranging information elements on a web page than with a template.

The present invention also permits control over what type of information elements can be placed on a web page. For example, a parent company can utilize the web authoring software module to restrict a franchise's access to the software module in order to control or monitor the creation of individual franchise web pages. The web authoring software can be programmed to restrict the type of information elements that are placed on a web page and the media that are placed in each information element.

The present invention can operate in a distributed computing environment. The invention can comprise a server computer that runs a software module operable for creating web pages viewable on the World Wide Web. Coupled to the server computer via the distributed computing environment can be clients who are capable of accessing the software module. The software module can comprise an editor operable for creating information elements on the web page and code operable for giving information elements functionality.

### BRIEF DESCRIPTION OF THE DRAWINGS

FIG. 1 is a block diagram illustrating the operating environment for an exemplary embodiment of the present invention.

FIG. 2 is a logic flow diagram illustrating an overview of an exemplary web authoring process.

FIG. 3A illustrates an exemplary display screen according to one embodiment of the present invention.

FIG. 3B illustrates an exemplary display screen of information element options according to the present invention.

FIG. 3C illustrates an exemplary display screen of further options for a table information element according to the present invention.

FIG. 3D illustrates an exemplary display screen of further options for the table information element and the generation of an actual table.

FIG. 3E illustrates an exemplary display screen of further options for individual cells of the table generated in FIG. 3D.

FIG. 3F illustrates an exemplary display screen of another table information element according to the present invention.

FIG. 3G illustrates an exemplary display screen of a completed table information element that could be derived from the table information element of FIG. 3F.

FIG. 3H illustrates an exemplary image that can be displayed by the present invention.

FIG. 3I illustrates an exemplary display screen for resizing an image.

FIG. 3J illustrates an exemplary display screen containing an image that has been resized according to the present invention.

FIG. 3K illustrates an exemplary display screen for editing an image according to the present invention.

FIG. 3L illustrates an exemplary display screen of further options for individual cells of the table represented by graphical icons.

FIG. 3M illustrates an exemplary display screen of a table with a calendar.

FIG. 3N illustrates an exemplary display screen of options for editing and managing a website.

FIG. 3O illustrates an exemplary display screen for a website image manager.

FIG. 4 is a logic flow diagram illustrating an exemplary process for editing or adding text to a web page.

FIG. 5 is a logic flow diagram illustrating an exemplary process for editing or adding a table to a web page.

FIG. 6 is a logic flow diagram illustrating an exemplary process for editing or adding an image to a web page.

FIG. 7 is a logic flow diagram illustrating an exemplary process for editing or adding a hyperlink to a web page.

FIG. 8 is a logic flow diagram illustrating an exemplary process for converting the format of an image to be added to a web page.

FIG. 9 is a logic flow diagram illustrating an exemplary process for resizing or editing an image added to a web page.

### DETAILED DESCRIPTION OF THE EXEMPLARY EMBODIMENTS

The present invention enables users without knowledge of HTML to create web pages viewable on the World Wide Web. Specifically, the present invention employs simple selectable lists of options to create information elements of varying size and to place them at any location on a web page. This is a significant improvement over conventional web authoring software that employs templates to create web pages. The present invention gives the user flexibility to design a customized web page of considerable complexity and originality.

Although the exemplary embodiments will be generally described in the context of software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the global Internet.

The detailed description which follows is represented largely in terms of processes and symbolic representations of operations in a distributed computing environment by conventional computer components, including remote file servers, remote computer servers, remote memory storage devices, a central processing unit (CPU), memory storage devices for the CPU, display devices and input devices. Each of these conventional distributed computing components is accessible by the CPU via a communications network.

The processes and operations performed by the computer include the manipulation of signals by a CPU or remote server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

The present invention also includes a computer program which embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flow charts and associated description in the application text, for example. Therefore, disclosure of a particular set of program code instructions is not considered necessary for an adequate understanding how to make and use the invention. The inventive functionality of the claimed computer program will be explained in more detail in the following description in conjunction with the remaining figures illustrating the program flow.

Referring now to the drawings, in which like numerals represent like elements throughout the several figures, aspects of the present invention and the preferred operating environment will be described.

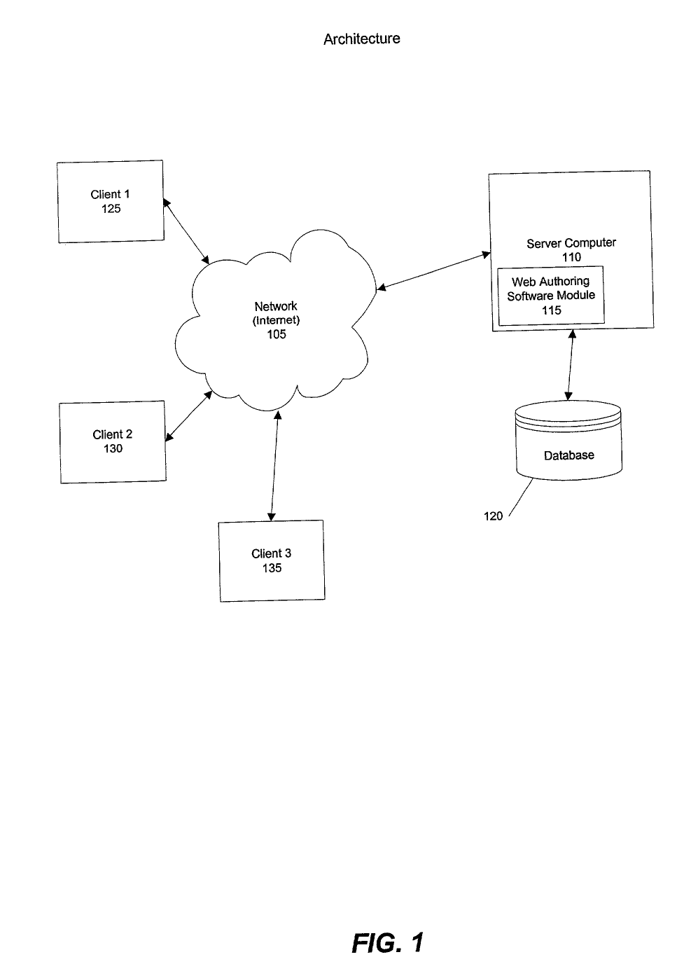

FIG. 1 illustrates various aspects of an exemplary computing environment in which the present invention is designed to operate. Those skilled in the art will appreciate that FIG. 1 and the associated discussion are intended to provide a brief, general description of the computer network resources in a representative computer network supporting the creation of customized web pages.

FIG. 1 illustrates an exemplary distributed computing environment. The distributed computing environment of FIG. 1 comprises a network 105, such as the Internet, with a First Client 125, Second Client 130, and Third Client 135 connected thereto. Also connected to the network 105 is a server computer 110 running a web authoring software module 115. Connected to the server computer 110 is a database 120 containing data such as images. In alternative embodiments of the invention, the database 120 may actually be part of the server computer 110. A client may access the web authoring software module 115 through the network 105. A client may create a web page using the web authoring software module 115. A client may also retrieve images and other information from the database 120 for use in creating the web page. FIG. 1 illustrates one software module 115 and 3 clients. However, the invention may be practiced with multiple software modules operating on one or more computer servers and being accessed by additional clients.

In one exemplary embodiment, the web authoring software module 115 can comprise an HTML editor and a JAVA Project Builder. The HTML editor provides the ability to position HTML objects in a web page and make such objects dynamic with JAVA code. One implementation of the preferred programming language that contains the HTML editor and JAVA Project Builder is APPLE WEBOBJECTS. However, as noted above, the invention should not be construed as limited to any one set of computer program instructions. Further, a skilled programmer would be able to write such a computer program to implement the disclosed invention without difficulty based on the flow charts and associated description in the application text, for example. Therefore, disclosure of a particular set of program code instructions, such as in APPLE WEBOBJECTS, is not considered necessary for an adequate understanding how to make and use the present invention.

### Exemplary Overview of Process

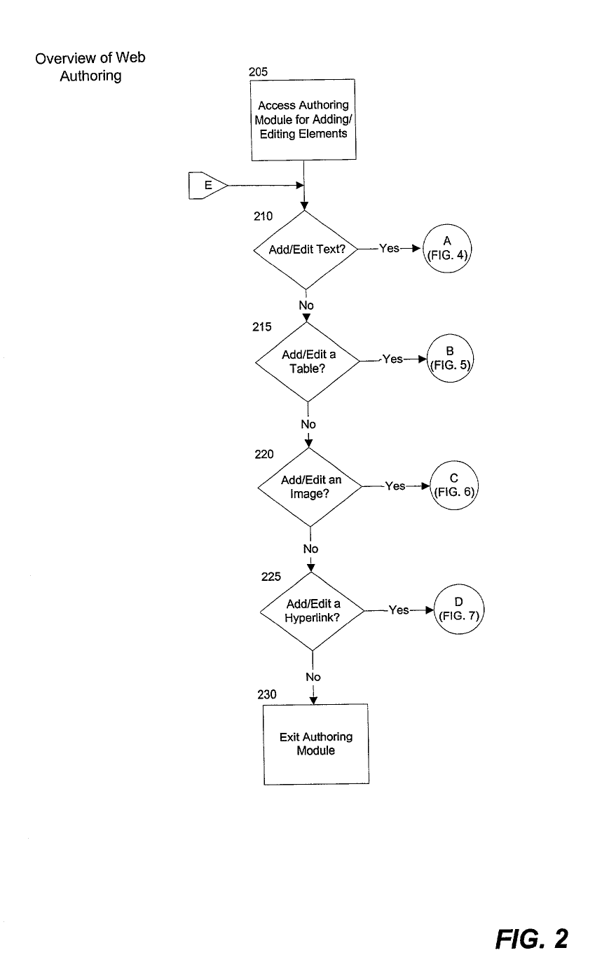

Referring now to FIG. 2, an exemplary process for creating a web page using the web authoring software module 115 is illustrated. In alternative embodiments of the present invention the steps set forth in FIG. 2 may occur in a different order and some of them may not occur at all. Also, the present invention is not limited to the web page information element options illustrated by these steps. Other information elements include, but are not limited to, calendars, events, clocks or time functions, web page hit counters, music, sound, movies or videos, and other like information elements.

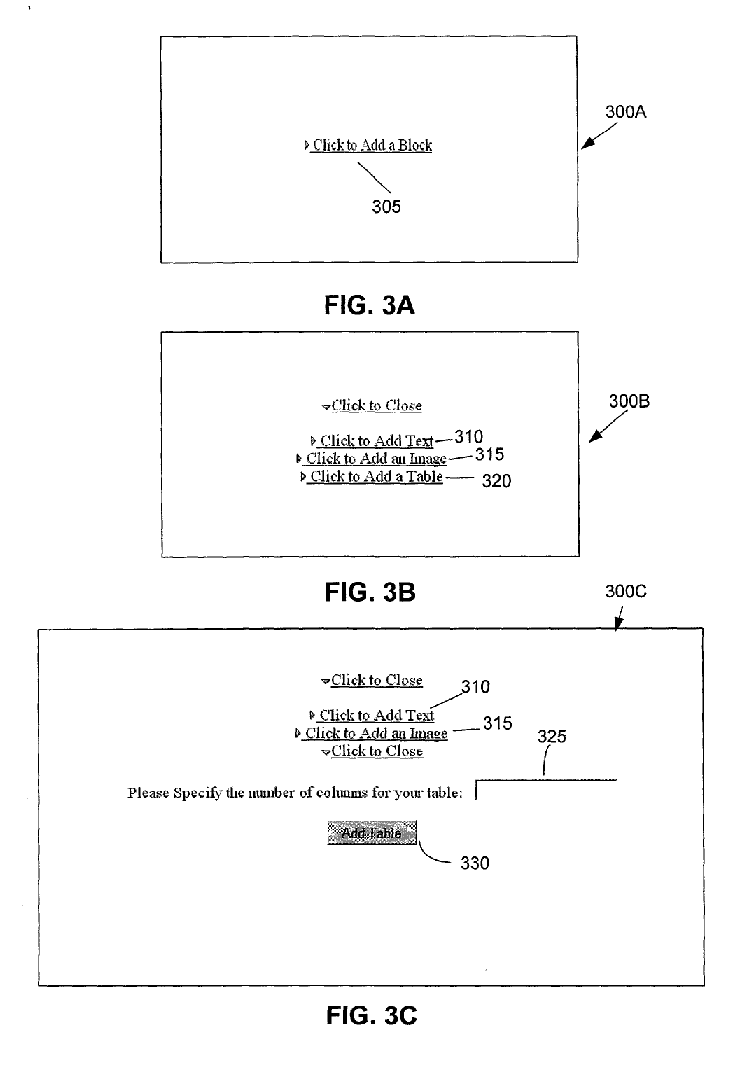

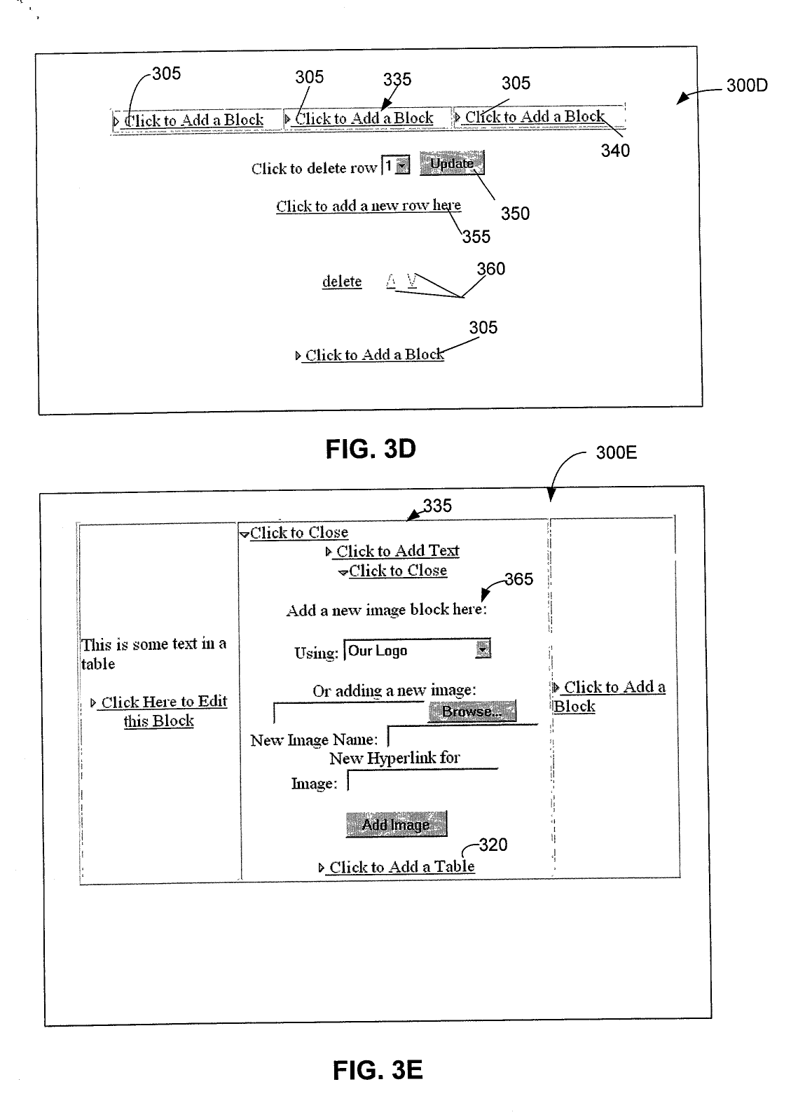

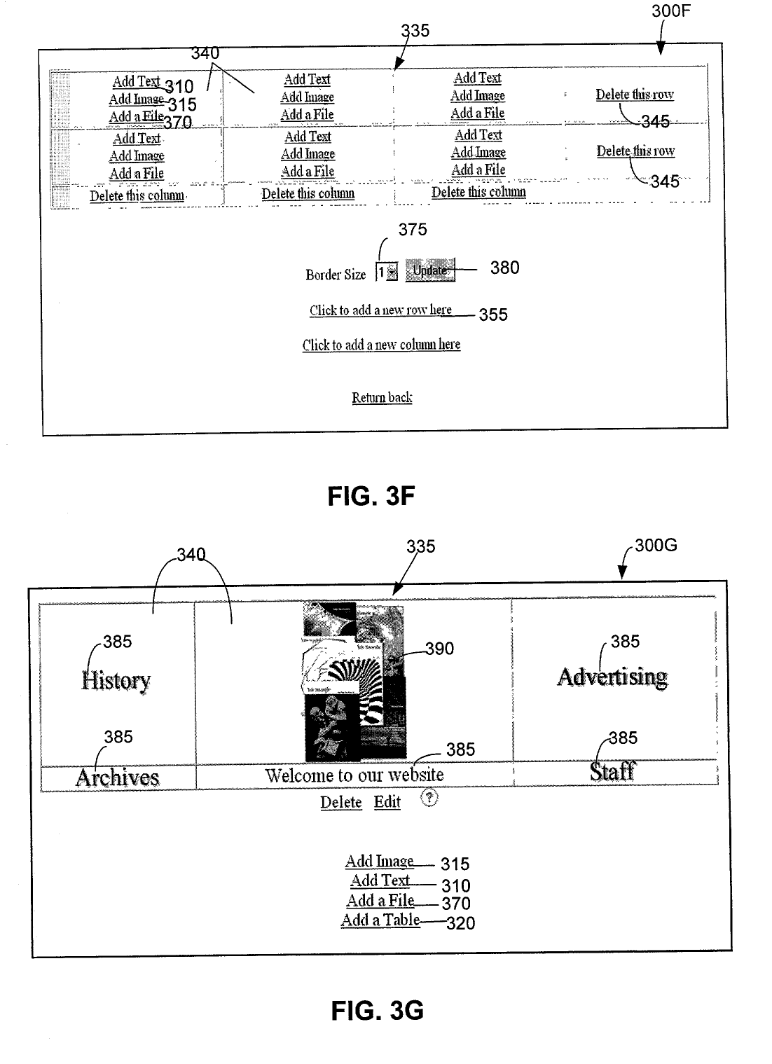

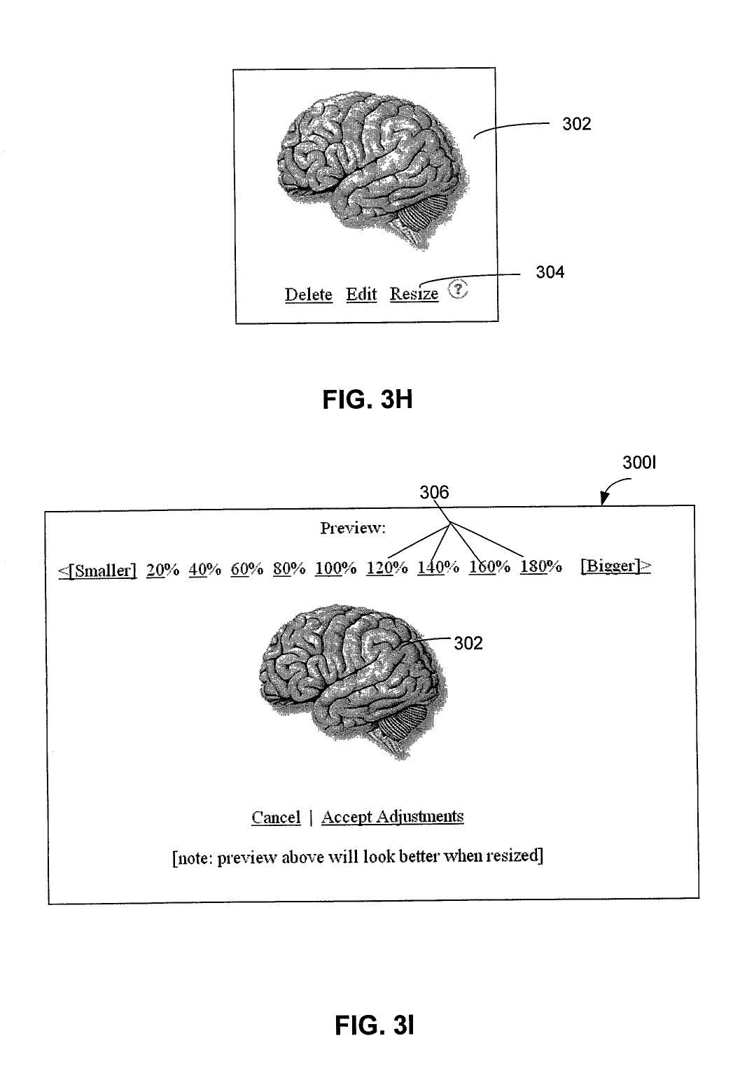

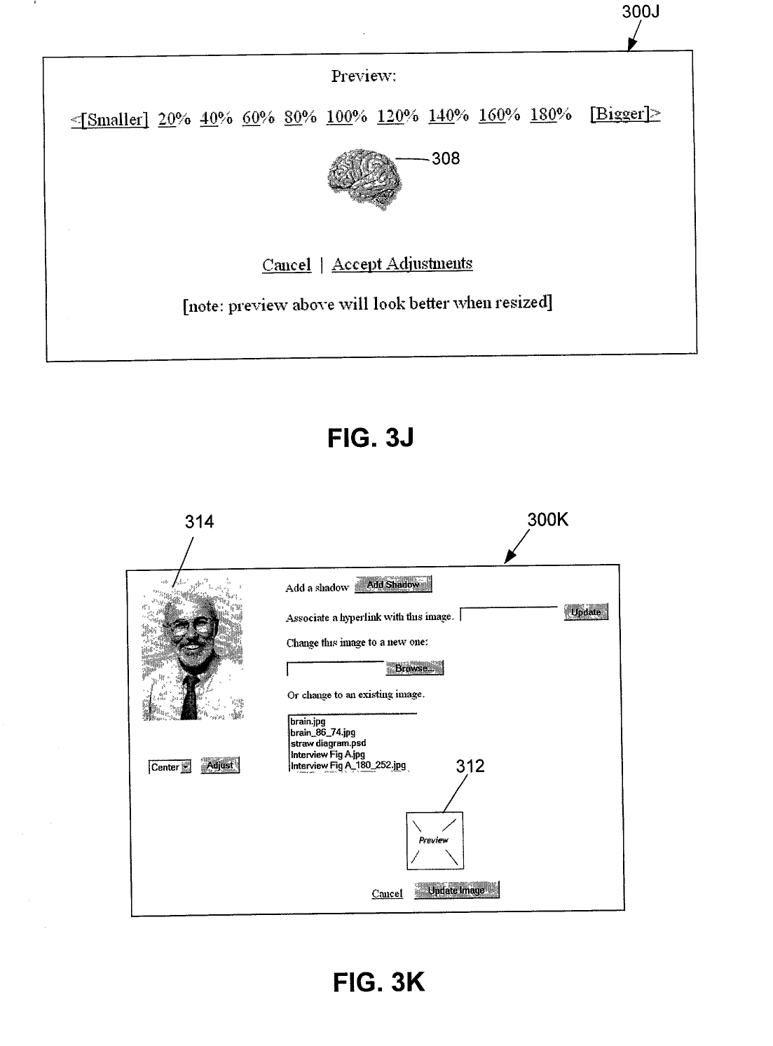

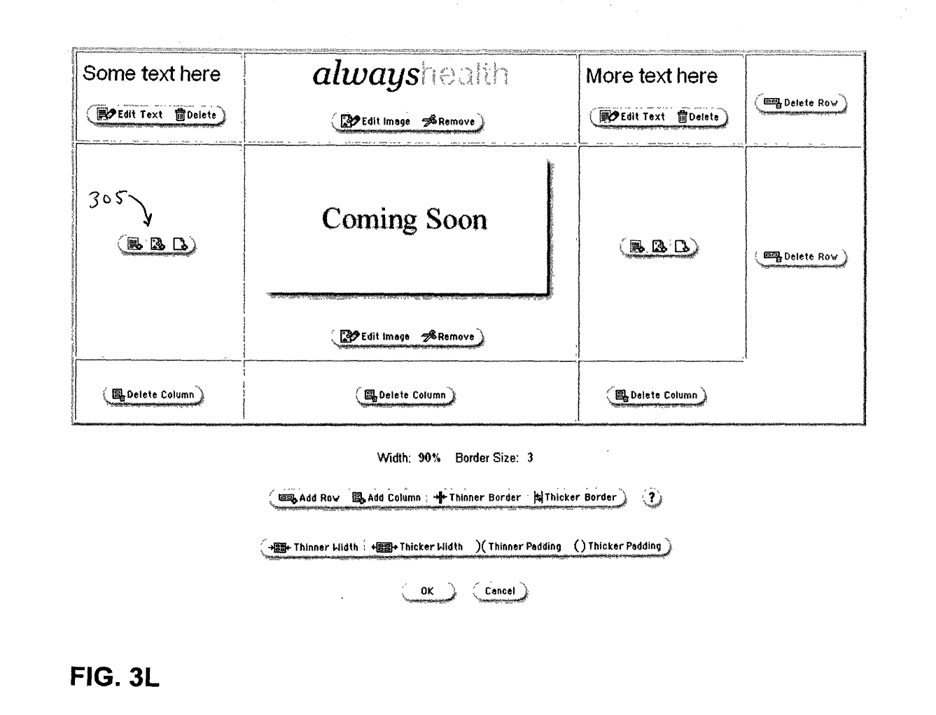

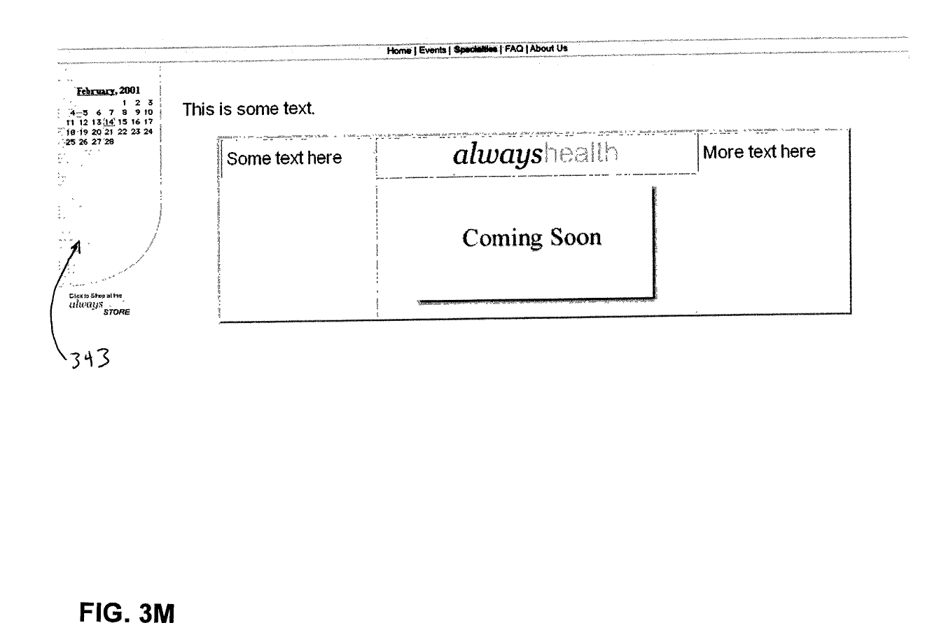

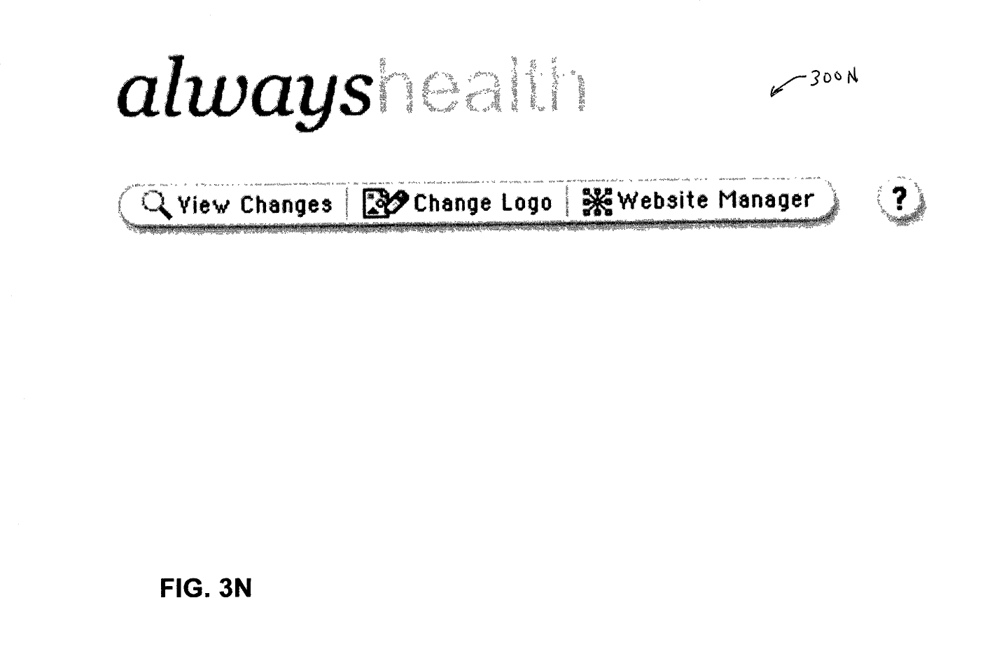

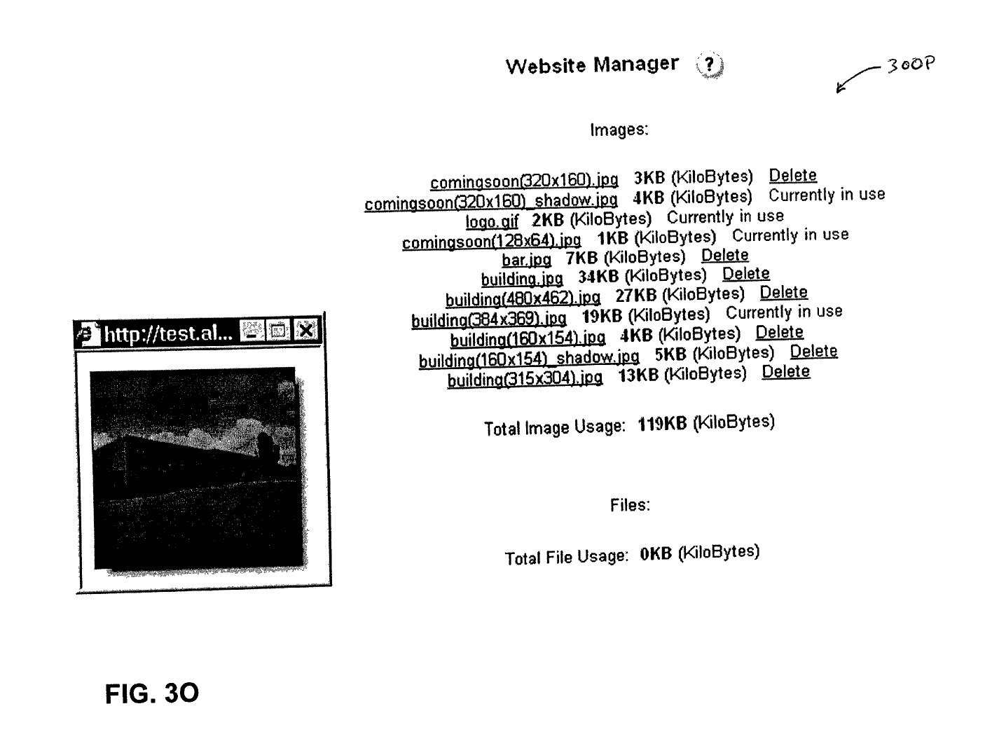

In step 205, a client accesses the web authoring software module 115 for creating or editing a web page. A client can use the web authoring software module 115 to position and edit information elements on a web page. The steps illustrated in FIG. 2 set out exemplary choices or web page options for a client as to what type of information element is to be positioned on a web page. The choices illustrated in FIG. 2 will generally be displayed as a list of options for the client on the web construction pages as illustrated in FIGS. 3A-3F (discussed below).

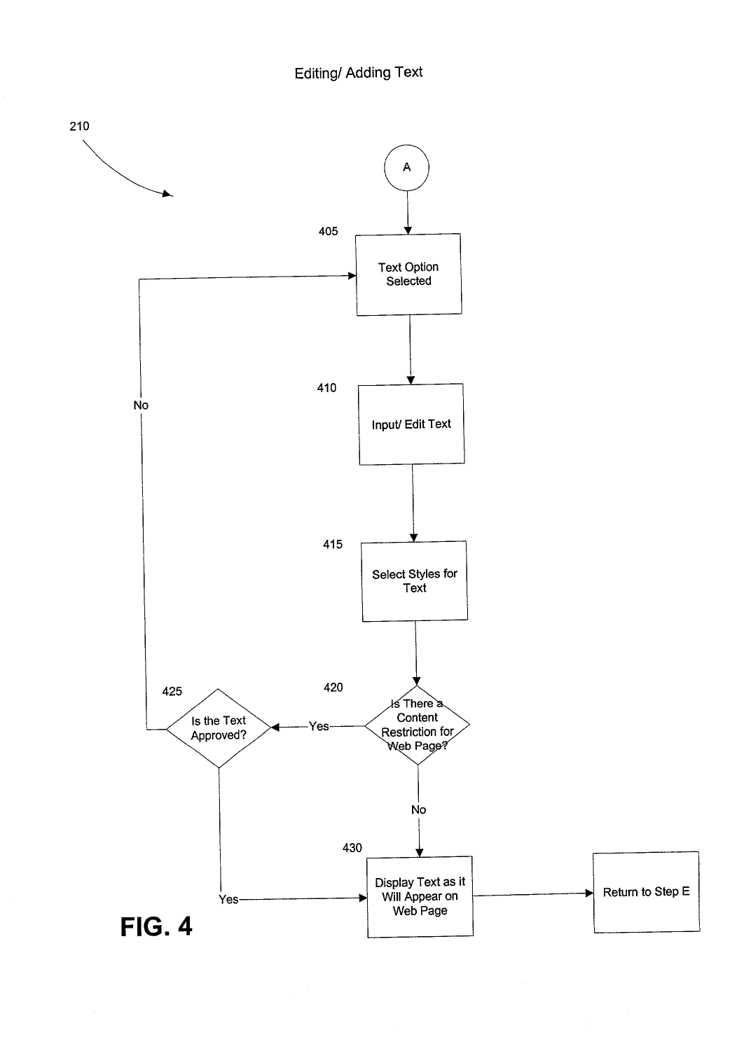

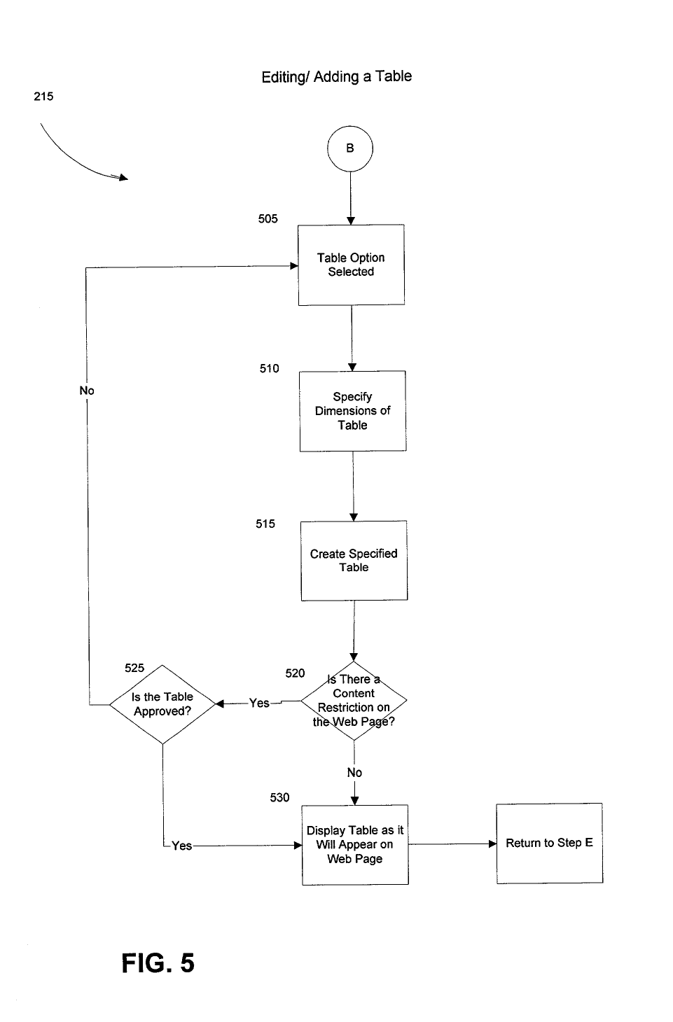

In step 210, text can be edited or added to the web page. Specifically, a client may choose to add or edit text on the web page. If a client does wish to add or edit text, the “Yes” branch will be followed to sub-process “A” of FIG. 4. If a client does not wish to add or edit text on the web page, the “No” branch is followed to step 215 where a client must decide whether or not to add or edit a table on the web page. If a client chooses to edit or add a table to the web page, the “Yes” branch is followed to FIG. 5 where an exemplary process for adding or editing a table is illustrated in greater detail. If a client does not wish to edit or add a table, the “No” branch is followed to step 220 where a client must decide whether to edit or add an image to the web page.

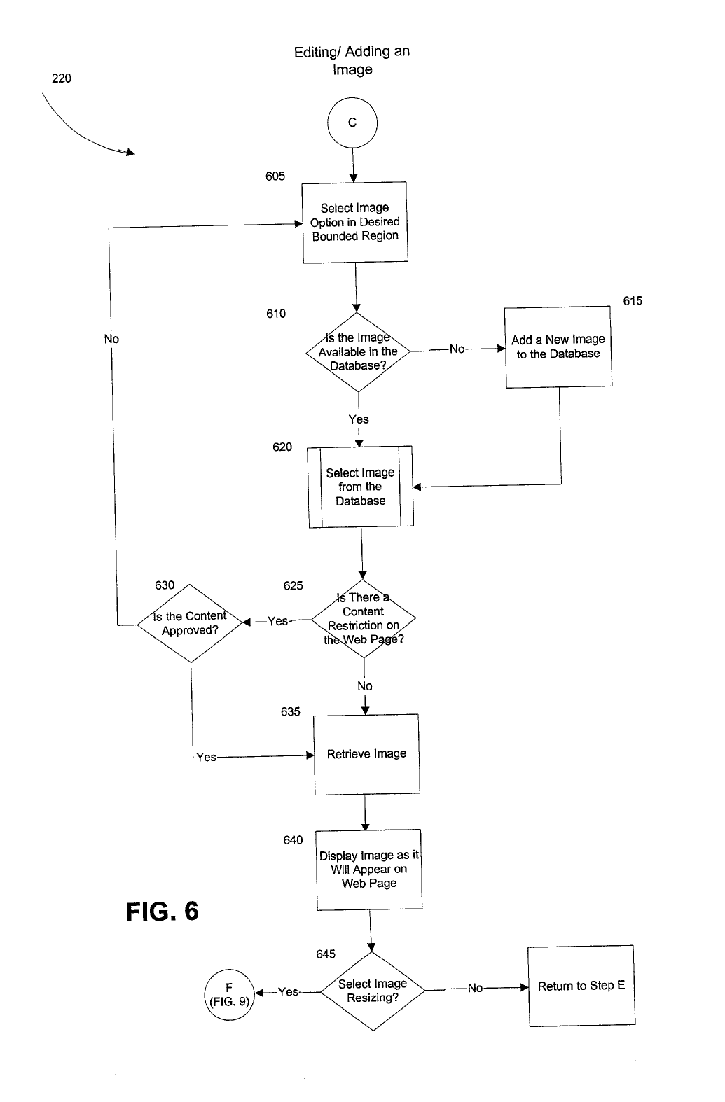

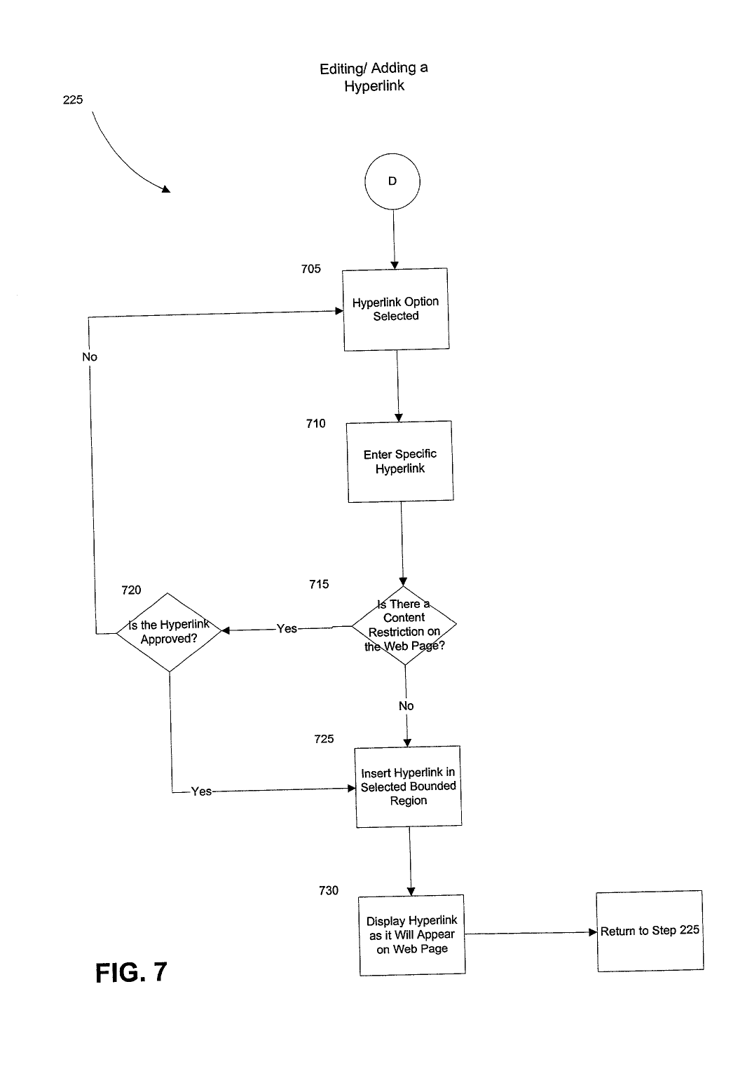

If a client wishes to edit or add an image, the “Yes” branch is followed to FIG. 6 where an exemplary process for editing or adding an image to a web page is illustrated in greater detail. If a client does not wish to edit or add an image, the “No” branch is followed to step 225 where a client must decide whether to edit or add hyperlink to the web page. If a client does choose to edit or add a hyperlink, the “Yes” branch is followed to FIG. 7 where the process for editing or adding a hyperlink to the web page is set forth in greater detail. If a client does not wish to edit or add a hyperlink to the web page, the “No” branch is followed to step 230 where the Client exits the web authoring software module 115.

### Exemplary Displays According to the Invention

Referring now to FIG. 3A, this figure is an illustration of an exemplary display 300 A according to the present invention, before any information elements have been created or added to a web construction page. Information element option 305 is first displayed and queries if an information element (also referred to as a “block”) is desired to be added to a web page. If Option 305 is activated, then additional options, such as an “Add Text” option 310, an “Add Image” option 315, and “Add Table” option 320 are displayed as illustrated in exemplary display 300B in FIG. 3B. These options correspond directly with some of the exemplary steps illustrated in FIG. 2.

In FIG. 3C, exemplary display 300C is generated in response to the selection of the “Add Table” option 320 in FIG. 3B. A table size field 325 is displayed so that size information for a customized table can be received. Once size information has 10 been entered, an “Add Table” button 330 can be activated.

In response to the activation of the “Add Table” button 330 and after the entry of size information in the table size field 325, table 335 of exemplary display 300D, in FIG. 3D, is generated. In this exemplary embodiment, three columns were selected for table 335. Within each cell 340 of table 335, an information element option 305, similar to the one illustrated in FIG. 3A, is positioned. In this way, separate information elements can be inserted into each cell 340 of the table 335. Information element options 305 can also be represented by graphical icons as shown in another exemplary display illustrated in FIG. 3L.

Upon activation of any of these information element options 305, customized information elements or additional formatting, such as the addition of another table 335 within a cell 340, can be inserted. This layering of information elements within a table 335 as well as the simple generation of a table 335 having separate information elements contained in separate cells 340, is referred to as the “nesting of information elements” which is typically not available in the conventional art. Information elements can be nested using options other than a table. For example, a user can create a calendar 343, as illustrated in FIG. 3M, and insert information elements such as an image, text, or a hyperlink within the calendar.

In addition to the information element options 305, table editing options such as a delete row option 345 and an “Update” button 350 can be provided. Further, additional table editing mechanisms such as “Add New Row” options 355 can be provided to permit adjustments to the size of table 335. Also, position adjustment mechanisms such as vertical movement buttons 360 can be provided such that the location of the table 335 or an information element can be changed. That is, information elements are sequentially placed on a page, and once a new element is added, a user can change the location of such a block vertically on the page using tc vertical movement buttons 360. While only vertical movement is illustrated, it is not beyond the scope of the present invention to employ other movement directions such as horizontal.

In response to the activation of an information element option 305 disposed in a central cell 340 of a table 335 as illustrated in FIG. 3D and activation of “Add Image” option 315 (not shown) within a central cell 340, image acquisition options 365 of a display 300E are generated as illustrated in FIG. 3E. With the image acquisition options 365, images can be retrieved from the database 120 or from a client-specified file location.

Referring now to FIG. 3F, this figure further illustrates another exemplary display 300F containing a table 335 that has been customized to have three columns and three rows. This figure also illustrates other exemplary options such as an “Add File” option 370, a “Border Size” option 375, and an “Update Button” 380 associated with the “Border Size” option 375.

FIG. 3G illustrates an exemplary display 300G with the table 335 (from FIG. 3F) after the entry of exemplary information elements. Table 335 contains several cells 340 with previews of exemplary text information elements 385 and exemplary image information elements 390. FIG. 3G demonstrates the versatility and customization of web pages that can be achieved with the present invention.

FIG. 3H illustrates an exemplary image 302 with a resizing option 304 that can be displayed by the present invention. Upon activation of the resizing option 304, an exemplary resizing display screen such as display screen 300I can be generated. Resizing increments 306 can be provided to permit a wide range of resizing for the image 302. After selecting one of the resizing increments, such as a forty-percent (40%) resizing increment, the display screen 300J of FIG. 3J can be generated. FIG. 3J illustrates the exemplary display screen 300J containing an image 308 that has been resized according to the present invention.

FIG. 3K illustrates an exemplary display screen 300K for editing an image according to the present invention. Exemplary display screen 300K can provide various editing options as well as a preview area 312 that can display a preview image of the base image 314 once any editing options are selected.

The web authoring software module 115 can also provide features for managing a website. A website can comprise a plurality of web pages, wherein each web page contains several information elements. FIG. 3N is an illustration of an exemplary display 300N. Display 300N provides the user with options for making changes to a website, viewing those changes, and managing the information elements comprising a website. FIG. 3P is an illustration of an exemplary display 300P for managing the images of a particular website. Display 300P provides the user with information about which images are being used in a website and which images have been deleted.

### Exemplary Sub-Processes of FIG. 2

Referring now to FIG. 4, the exemplary sub-process “A” of FIG. 2 for editing or adding text to a web page is illustrated. Continuing from step 210 of FIG. 2, in step 405 a client selects the “Add Text” option 310 to place text on a web page. In step 410, a client inputs the text to be placed on the web page. Alternatively, a client may edit text which may already exist on a web page. In step 415, a client may choose from a variety of styles for the text including text size and font. In step 420, the web authoring software module queries for any content restrictions on the web page imposed by the owner of the web authoring software module 115. If there are no restrictions, the “No” branch is followed to step 430 where the text will be previewed or displayed on the web page.

If there is a content restriction, the “Yes” branch is followed to step 425 where the web authoring software module 115 checks to make sure the text is approved. For example, the entered text can be checked against a table of approved text created by the administrator of the web authoring software module 115. If the text is not approved, the “No” branch returns the user to step 405. If the text is approved, the “Yes” branch is followed to step 430 where the text is displayed as it will appear on the web page. The process returns to step E of FIG. 2. where a client may then choose to insert additional text or to create other elements on the web page.

Referring now to FIG. 5, the exemplary sub-process “B” of FIG. 2 for editing or adding a table to a web page is set forth in this figure. Proceeding from step 215 of FIG. 2, in step 505 a client selects the “Add Table” option 320 to place a table within the web page. In step 510, the web authoring software module 115 queries a client as to the dimensions of the table. A client inputs the desired dimensions, for example, the number of rows and number of columns in the table. In step 515, the web authoring software module 115 creates the specified table. In step 520, the web authoring software module 115 queries for any content restrictions on the web page. If there is no content restriction, the “No” branch is followed to step 530 where the table is displayed as it will appear on the web page.

If there is a content restriction, the “Yes” branch is followed to step 525 where the web authoring software module 115 checks to see if a table is approved for the web page. If a table is not approved, the “No” branch is followed and a client is returned to step 505. If the table is approved, the “Yes” branch is followed to step 530 where the table will be displayed on the web page. The process returns to step E of FIG. 2 to add or edit additional elements to the web page.

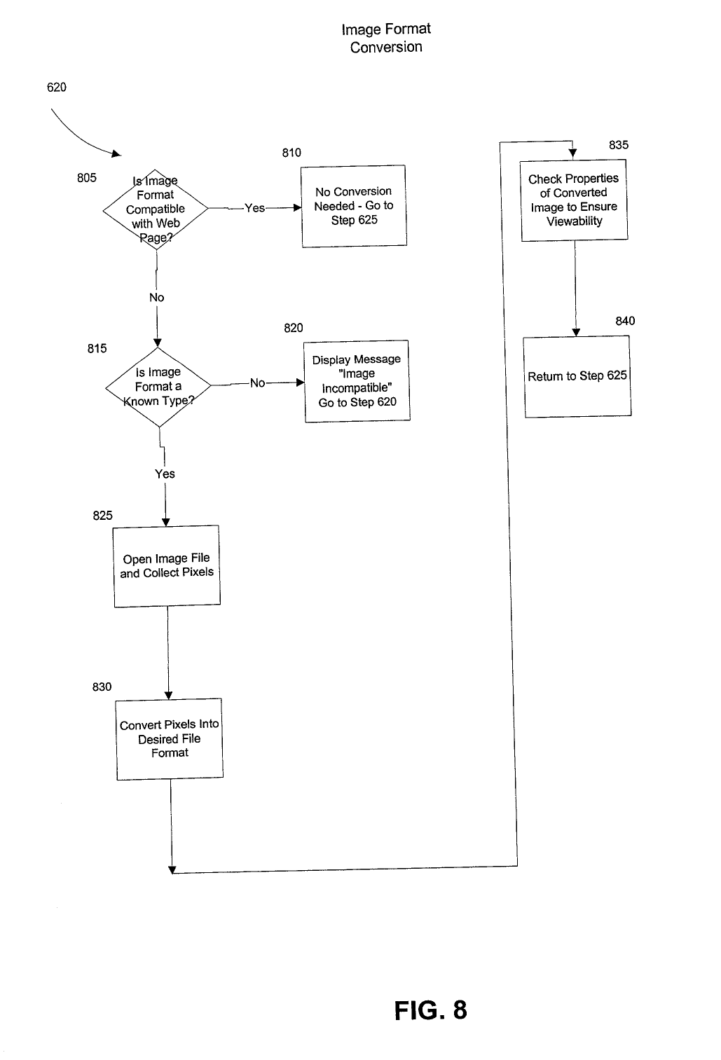

FIG. 6 sets forth an exemplary flow diagram for sub-process “C” of FIG. 2 for editing or adding an image to a web page. Continuing from step 220 from FIG. 2, in step 605, a client selects the image input option 315. In step 610, a client can browse for an image to place on the web page. If there is an image available in the database 120, a client selects that image and it will be placed on the web page. If an image is not available in the database 120, a client may add a new image to the database in step 615. Once a client adds an image to the database 120, the client can retrieve copies of the image from the database 120 instead of uploading the same image. Such images that are uploaded to database 120 can be referred to as assets, as illustrated in the tables below. Also, the present invention is not limited to storing only images on database 120. A client can upload any information to database 120 for future use on the same web page or other web pages. In routine 620, the image selected by the client is retrieved from the database 120. Further details of routine 620 are illustrated in FIG. 8.

In step 625, the web authoring software module queries for any content restriction on the web page. If there is no restriction, the “No” branch is followed to step 635 and the image is retrieved. If there is a content restriction, the “Yes” branch is followed to step 630 where the web authoring software module 115 checks to see if the image is approved. If the image is not approved, the “No” branch returns a client to step 605. If the image is approved, the “Yes” branch is followed to step 635 where the image is retrieved. In step 640, the web authoring software module 115 displays or previews the image on the web page.

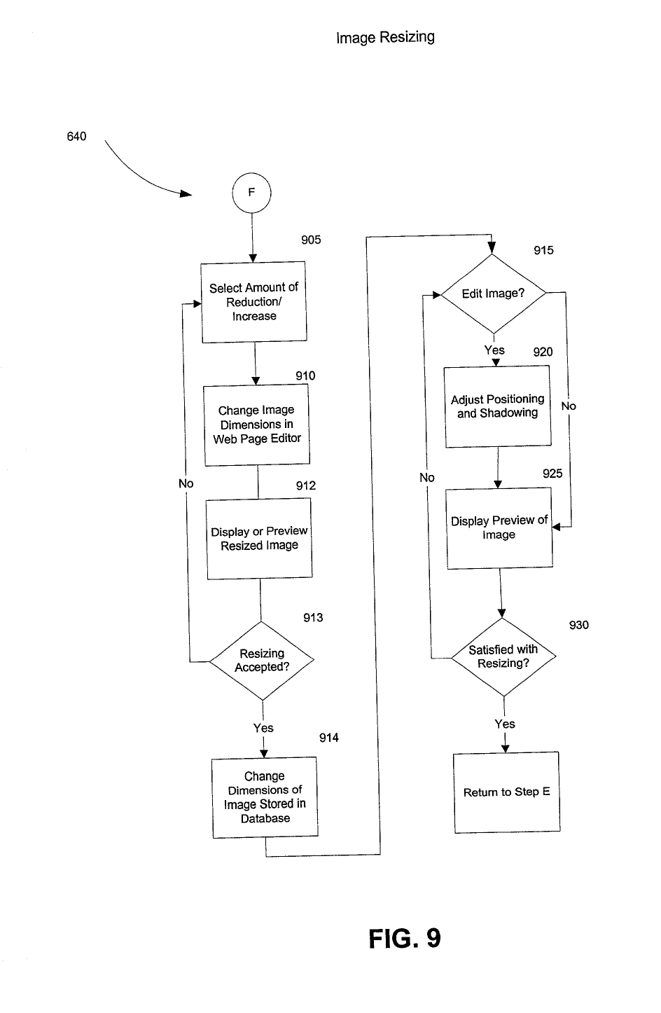

In step 645, a client can choose to select an image resizing option 304 as illustrated FIG. 3H. If a client does not wish to resize the image, the “No” branch is followed to step E of FIG. 2. If a client does wish to resize the image, the “Yes” branch is followed to exemplary sub-process “F,” which is set forth in greater detail in FIG. 9.

Referring to FIG. 7, the exemplary sub-process B, of FIG. 2, for editing or adding a hyperlink to a web page is illustrated. Proceeding from step 225 from FIG. 2, in step 705, a client selects a hyperlink input option. In step 710, a client may enter a specific hyperlink. The hyperlink will link the web page being constructed to another web page on a distributed computer network, such as the World Wide Web. In step 715, the web authoring software module 115 queries for any content restrictions on the web page. If there are no restrictions, the “No” branch is followed to step 725 where the hyperlink is inserted into the page. If there is a restriction, the “Yes” branch is followed to step 720 where the web authoring software module 115 verifies to see if the hyperlink is approved. If the hyperlink is not approved, the “No” branch returns a client to step 705 for selecting another hyperlink. If approved, the “Yes” branch is followed to step 725 where the web authoring software module 115 inserts the hyperlink into the web page. In step 730, the web authoring software module previews or displays the web page with the hyperlink. The process returns to step E of FIG. 2.

FIG. 8 and FIG. 9 illustrate exemplary processes for subroutines listed in FIG. 6. Specifically, FIG. 8 refers to routine 620 of FIG. 6 and explains in greater detail the process for converting the format of an image. In step 805, web authoring software module 115 checks to see if the selected image is compatible with the web page. The web authoring software module 115 looks at the file header information to determine the file type. Typically, joint photographic experts group (jpeg), graphics interchange format (gif), and portable network graphics (png) file formats are compatible with the web pages. If the file is compatible, no conversion of the image is necessary and the “Yes” branch is followed to step 810 wherein a client is returned to step 625 of FIG. 6. If the format is not compatible, the “No” branch is followed to step 815 where the web authoring software module 115 checks to see if the image is of a known format. Commonly used and known formats include, but are not limited to, tagged image file format (tiff), Microsoft Windows bitmap (bmp), Adobe photoshop (psd), and Apple graphics (pict) file formats.

If the image is of an unknown format, in step 820 an image incompatible message will be displayed and a client will be returned to step 620 of FIG. 6 to select another image. If the image is of a known format, the “Yes” branch is followed to step 825 where the image file is opened and the web authoring software module 115 collects the pixels of the image. In step 830, the pixels are converted into the desired file format. The conversion process typically involves two steps employing commonly available decoders and encoders that correspond to each file type. First, a decoder, which corresponds to the incompatible file format, decodes the pixels of the image by performing predetermined mathematical computations. Second, an encoder, which corresponds to one of the compatible file formats, performs additional mathematical computations that place the pixels into a compatible file format. In step 835, the web authoring software module 115 checks the properties of the converted image to ensure that it can be viewed on the web page. Checking the properties comprises an evaluation of the height and width of the image to ensure that it can be displayed in any browser. If this is the first time the image is uploaded, the height and width are checked when the image is opened. If the image is has been used before and is stored in the database 120, the height and width information will also be available in the database 120. Finally, once the conversion is complete, the process returns to step 625 of FIG. 6.

Referring to FIG. 9, an image resizing subroutine F from FIG. 6 is illustrated. FIG. 9 is a logic flow diagram of an exemplary process for altering the size of an image 302 placed on a web page. In step 905, the client can select a resizing increment 306 to reduce or increase the size of the image 302. In step 910, the web authoring software module 115 changes the image dimensions in the HTML code with the web page editor. By altering the dimensions of the image 302 with HTML code, the client computer can perform the resizing of the image. In this way, no server-side image resizing is completed until the client approves or confirms the resizing of the image 302. In step 912, the resized image 308 is displayed or previewed as illustrated in FIG. 3J. In decision step 913, it is determined whether the resizing has been accepted. If the inquiry to decision step 913 is negative, then the “No” branch is followed back to step 905. If the inquiry to decision step 913 is positive, then the “Yes” branch is followed to step 914 in which the sizing adjustments for image 308 are stored in the database 120.

In step 915, a client may also choose to edit the image. If no editing is desired, the “No” branch is followed to step 925. If a client, does wish to edit the image, the “Yes” branch is followed to step 920. In step 920, the image can be edited with options such as adding shading and adjusting the positioning of the image as illustrated in FIG. 3K. In step 925, the web authoring software module 115 displays a preview image of the image 314 being edited so that a client may see how the image will look on the web page. In FIG. 3K, it is noted that a preview area 312 is blank since user options have not been selected at this point in time. Upon receiving a user option, such as adding a shadow to the image 314, the preview area 312 would contain a preview image having the one or more user selected options. In step 930, the web authoring software module 115 queries to determine if the editing of the image 314 is acceptable. If not, the “No” branch is followed back to step 905 where further editing or resizing may be done. If yes, a client is returned to step E of FIG. 6

### Exemplary Tables Stored in Database 120

The following tables illustrate an exemplary organization and content of information that can be stored in database 120. The present invention is not limited to the number and type of tables shown. They are being provided as mere examples of how information elements of the present invention can be stored in database 120. As noted above, the term “information element” is also referred to as a “block”. Also the term “asset” in the following tables can denote any uploaded information element provided by a user:

PAGE TABLE

| Rows | Description |
|---|---|
| ID | Unique index for this table. |
| PageType | This is the type of page the user chooses. The type of blocks |
| | allowed on a particular page can depend on this value. For |
| | instance, a PageType of Calendar can allow for calendar block |
| | components to be available as types of blocks. PageTypes |
| | can include: Calendar, Links, FAQ, Normal, Framed. |
| PageName | This is the particular name the user designated for this |
| | element. These can include: “Home,” “Links,” |
| | “Events,” “About Us,” and any number of custom named |
| | pages the user desires |
| UserID | This is a to-one relationship to the User table below. |

BLOCK TABLE

| Rows | Description |
|---|---|
| ID | Unique index for this table. |
| BlockType | This is the type of block the user chooses for this page. |
| | The type of blocks allowed include but are not restricted |
| | to: Text, Image, QuickTime Movie, Sound, Table, |
| | Calendar Component, Mailing List, Chat Component, |
| | Message Board. |
| AssetID | This is a to-one relationship to the Asset table below. |
| | Depending on the BlockType, this Asset can be an |
| | image, text, or other media type. |
| PageID | This is a to-one relationship to the Page table above. |
| | This tells where to place this block in the user's website. |
| BlockPriority | This element describes the location of a block within |
| | the given page. This allows for blocks to be moved |
| | around by the user. |

INDIVIDUAL CELL TABLE
(For use with Blocks that are Table Elements)

| Rows | Description |
|---|---|
| ID | Unique index for this table. |
| BlockID | This is a to-one relationship to the Block Table above. |
| | If a Block is a Table element, then that block will be |
| | linked to many of these Individual Cell Items. |
| SubBlockID | This is a to-one relationship to the Block table above. |
| | This allows for infinite nesting of tables and blocks. |
| ColumnNumber | This indicates which column this particular cell |
| | relates to in the original Table Block. |
| RowNumber | This indicates which row this particular cell relates to |
| | in the original Table Block. |

ASSET TABLE

| Rows | Description |
|---|---|
| ID | Unique index for this table. |
| AssetType | This is a description of the type of Asset this element |
| | contains. Possible Asset types include: Text, Image, |
| | QuickTime Movie, Sound. |
| AssetData | This is the actual data the type above describes. If this is |
| | a text Asset, for instance, the data contained here will be |
| | the actual text. |
| AssetLocation | This describes the location of the Asset on the server. |
| | This is used for large sized items such as Images, |
| | Movies, and Sound. |
| UserID | This is a to-one relationship to the User table below. |

USER TABLE

| Rows | Description |
|---|---|
| ID | Unique index for this table. |
| UserInfo | This is a description of the user. This includes Address, |
| | Email, Credit-Card Information, etc. |

In conclusion, the present invention enables and supports the creation of complex web pages with a simple method. The invention allows a user to access an authoring software module and create a web page of varied design. A variety of information elements such as tables, text, images, hyperlinks, music, sound, and video may be positioned and edited according to preferences of a client.

It will be appreciated that the present invention fulfills the needs of the prior art described herein and meets the above-stated objects. While there has been shown and described the preferred embodiment of the invention, it will be evident to those skilled in the art that various modifications and changes may be made thereto without departing from the spirit and the scope of the invention as set forth in the appended claims and equivalence thereof. Although the present invention has been described as operating on the World Wide Web, it should be understood that the invention can be applied to other types of distributed computing environments.

What is claimed is:

1. A method for creating a customized web page comprising the steps of:
storing a web authoring software module on a storage device;
providing access to a web authoring software module via a distributed computing network;
displaying one or more options for editing existing information elements when existing information elements are displayed;
displaying one or more options for adding information elements within a web page;
in response to receiving the selection of an information element editing option,
displaying one or more supplemental information editing options associated with the selected option;
in response to receiving the selection of an adding option, displaying one or more supplemental information element adding options associated with the selected option; and
displaying a preview of one or more information elements, whereby position, size, and content of the information elements are customizable in accordance with the options selected by the user.

2. The method of claim 1, wherein the one or more information elements comprise at least one of text, an image, a table, a movie, music, a hyperlink, and a sound.

3. The method of claim 1, further comprising the steps of:
displaying an option to add a table; and
in response to receiving a selection of adding a table, requesting size information for the table.

4. The method of claim 3, wherein said size information comprises at least one of a number of rows and columns for the table.

5. The method of claim 3, further comprising the steps of:
receiving size information for the table;
displaying the table in accordance with the received size information; and
displaying one or more options within each cell of the table.

6. The method of claim 1, further comprising the steps of:
displaying an option to add an image to the web page;
in response to receiving a selection of the option to add an image to the webpage, retrieving an image from a database coupled to the web authoring software module; and
displaying a preview of the image on the web page.

7. The method of claim 6, further comprising the step converting the image from a first format to a second format.

8. The method of claim 6, further comprising the steps of:
receiving a selection to resize the image;
altering computer code accessed by a browser; and
redisplaying the image according to the altered code.

9. The method of claim 1, further comprising the steps of:
displaying an option to add a hyperlink to the web page;
in response to receiving a selection of the option to add a hyperlink to the webpage, receiving the address of the hyperlink; and
displaying the address on the web page.

10. The method of claim 1, further comprising the step of restricting one or more types of information elements that can be added to the web page.

11. The method of claim 1, further comprising the step of adding one or more tables within an existing table displayed on the web page.

12. A computer-readable medium having computer-executable instructions for performing the steps recited in claim 1.

13. A method for creating an electronic file viewable on a distributed computing network comprising the steps of:
storing an authoring software module on a storage device;
accessing the authoring software module via the distributed computing network, the authoring software module operable for creating an electronic file viewable on the distributed computing network;
selecting an information element to add to the electronic file, the element having a size and a location which is adjustable; and
displaying a preview of the electronic file as it will appear as viewed on a web browser accessing the file via the distributed computing network.

14. The method of claim 13, wherein the step of accessing the authoring software module on the distributed computing network comprises accessing from a remote client coupled to the distributed computing network the software module, the authoring software module residing on a server computer.

15. The method of claim 13, wherein the information element selected to add to the electronic file comprises at least one of text, an image, a table, a movie, music, a hyperlink, and a sound.

16. The method of claim 13, further comprising the step of retrieving an image information element from a database coupled to the distributed computing network.

17. A computer-readable medium having computer-executable instructions for performing the steps recited in claim 13.

18. A system for creating files of information readable on the World Wide Web comprising:
a distributed computer network;
one or more clients coupled to the distributed computer network; and
a software module accessible on the distributed computer network, the software module operable for creating a web page comprising one or more information elements, the information elements being formatted and positioned by said software module, a size and a position of each information element being unconstrained and the information elements comprising at least one of text, an image, a table, a movie, music, a hyperlink, and a sound.

19. The system of claim 18, wherein the software module restricts one or more types of information elements based upon instructions received from a user.

20. The system of claim 18, wherein the software module comprises at least one of an HTML editor operable for creating the elements and JAVA code program operable for controlling the functionality of the elements.
